(19) United States
(12) Patent Application Publication
(10) Pub. No.: US 2017/0320675 A1
(43) Pub. Date: Nov. 9, 2017

(54) BELT CONVEYOR WITH A DEVICE FOR ASSESSING THE TENSION OF THE BELT

(71) Applicant: René Brunone, Saint-Marcel (FR)

(72) Inventor: René Brunone, Saint-Marcel (FR)

(21) Appl. No.: 15/582,696

(22) Filed: Apr. 30, 2017

(30) Foreign Application Priority Data
May 3, 2016 (FR) 1653983

(51) Int. Cl. B65G 43/02; G01S 15/08; B65G 23/44

(52) U.S. Cl. CPC B65G 43/02; B65G 23/44; G01S 15/08

(57) ABSTRACT

The belt conveyor comprises: a conveyance belt (3) having at least one longitudinal segment (17) tensioned between first and second tension members; a device (21) for assessing the tension of said segment (17), laid out for assessing, in a determined measurement point located longitudinally between the first and second tension members, a deviation of the segment (17) relatively to a reference value, the deviation being taken along a determined measurement direction forming a non-zero angle with the longitudinal direction.

### CROSS-REFERENCE TO RELATED APPLICATION

This application claims priority to French Patent Application No. 16 53983, filed by inventor Rene Brunone on May 3, 2016.

### FIELD OF THE INVENTION

The invention generally relates to belt conveyors.

### BACKGROUND OF THE INVENTION

In such a conveyor, the tension of the conveyance belt has direct consequences on the behavior of the belt, and therefore on the proper operation of the conveyor. If the belt is not sufficiently tensioned, it may move aside transversely and will rub on an element of the chassis, so that the chassis risks being damaged. Further, the belt risks slipping around the motor return drum upon starting. Moreover, the protections, the rotating elements and the other elements which may be in contact with the belt may be prematurely worn because of the rubbing of the belt.

### SUMMARY

In this context, the invention is directed to proposing a belt conveyor not having the defects above.

For this purpose, the invention deals with a conveyor comprising:
a conveying belt having at least one longitudinal segment tensioned between first and second tensioning members;
a device for assessing the tension of said segment, laid out in order to assess, in a determined measurement point located longitudinally between the first and second tensioning members, a deviation of the segment relatively to a reference level, the deviation being taken along a determined measurement direction forming a non-zero angle with the longitudinal direction.

The device for assessing the tension may assess the tension of the belt segment on which it is implanted, this segment being typically a portion of the return strand of the belt suspended between two consecutive supporting stations. The tension is measured by assessing the variation of the sag of the belt segment relatively to a reference level typically corresponding to the level of the segment when the belt is optimally tensioned for proper operation. Indeed, when the belt segment is not sufficiently tensioned, the sag of the belt segment increases, so that the segment is located under the reference level. The deviation increases when the tension decreases. On the contrary, if the belt is too tensioned, the sag of the belt segment is reduced. The belt segment is then located above the reference level.

The assessing device therefore gives the possibility of easily detecting a defect in the tension of the conveying belt, and of correcting the latter before other elements of the belt conveyor such as the chassis, or the protective elements, are damaged.

The belt conveyor may also have one or several of the characteristics below, considered individually or according to all the technically possible combinations:
the conveyor comprises a plurality of supporting stations for the conveying belt, the measurement point being located between two consecutive supporting stations separated longitudinally by a determined total length, a central point being located longitudinally at an equal distance from said two consecutive supporting stations, the measurement point being located at a longitudinal distance from the central point of less than 15% of the total length;
the measurement direction is substantially perpendicular to the longitudinal direction;
the assessing device comprises an ultrasonic distance sensor;
the assessing device comprises:
   a follower member, laid on the segment to said measurement point and bearing at least one movable marking;
   a fixed member, with a position independent of the tension of the segment and bearing at least a fixed marking;
   the deviation of the segment relatively to the reference level being assessed by the position of the movable mark relatively to the fixed mark;
one of the fixed marking or of the movable marking comprises a window, the other one of the fixed marking and of the movable marking comprising at least one mark not appearing in the window when the deviation of the segment relatively to the reference level is less than a predetermined value and appearing in the window when the deviation of the segment relatively to the reference level is greater than the predetermined value;
the fixed marking comprises a fixed mark, the movable marking comprising a movable mark coinciding with the fixed mark when the belt segment has a rated operating tension;
the conveyor includes a chassis for guidance and support of the belt, the follower member including an arm bearing a supporting member laid on the belt and a connection of the arm to the chassis allowing displacement of the arm relatively to the chassis in a plane containing the measurement direction;
the follower member comprises a supporting member laid on the belt and a sliding connection of the supporting member to the fixed member allowing sliding of the supporting member relatively to the fixed member along the measurement direction; and
the supporting member is a wheel.

### BRIEF DESCRIPTION OF THE DRAWINGS

Other features and advantages of the invention will become apparent from the description below, given as an indication and by no means as a limitation, with reference to the appended figures, wherein:

FIG. 1 is a schematic simplified illustration of a belt conveyor;

FIG. 2 is a perspective view of the device for assessing the tension of the conveyor of the invention, for a first embodiment of the invention;

FIG. 3 is a schematic illustration of the shape of a belt segment when the belt has its rated operating tension (solid lines) and when it has a lower tension (dashed lines);

FIG. 4 is an enlarged view of a portion of FIG. 2, showing a second embodiment of the invention;

FIG. 5 is a schematic illustration of the position of the supporting member, of the movable marking and of the fixed marking when the belt is at its rated tension and when the belt has an abnormally low tension; and

FIG. 6 is a schematic simplified illustration of a belt conveyor illustrating an alternative of the first embodiment of the invention.

### DETAILED DESCRIPTION

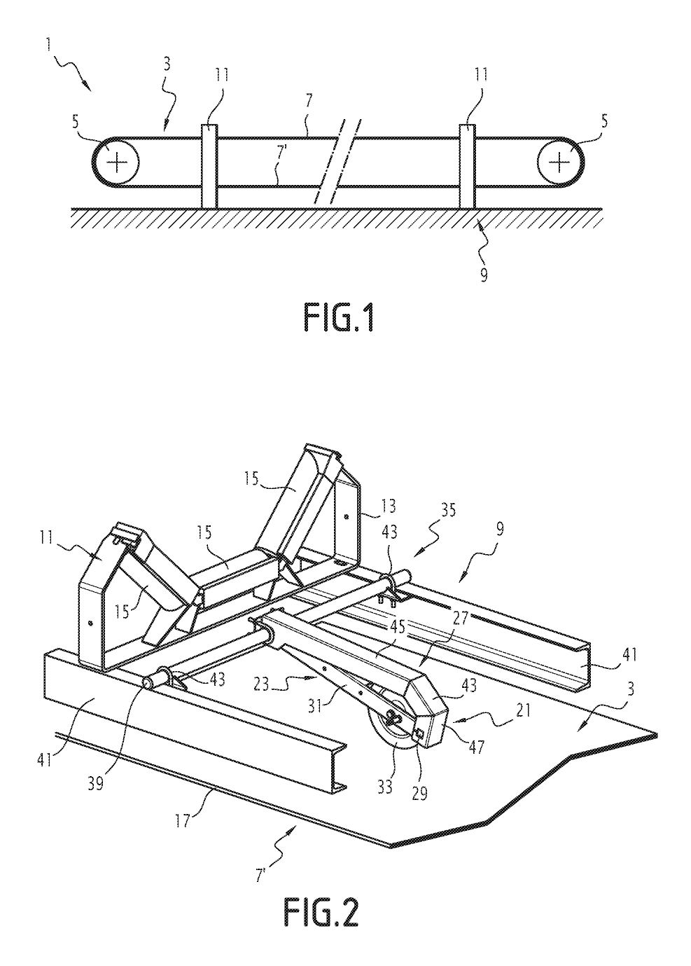

The belt conveyor 1 illustrated in FIG. 1 is intended for the transport of bulk materials, for example of the divided materials such as sand, gravels. It comprises a conveying belt 3, typically laid out as a loop around return drums 5 located at both ends of the belt conveyor. The belt thus includes two strands 7, 7′, each strand 7, 7′ extending from one return drum 5 to another.

Moreover, the belt conveyor 1 includes a chassis 9 for guiding and supporting the belt 3. This chassis 9 comprises several supporting stations 11, distributed longitudinally along the belt conveyor. The strand 7 of the conveying belt is provided for transporting materials. It is laid out as a trough.

For this purpose, and as visible in FIG. 2, the supporting stations 11 dedicated to the conveyance strands includes a bearing structure 13 and a plurality of supporting members 15 mounted on the bearing structure 13.

The conveyance strand 7 lies directly on the supporting members 15. In the example illustrated in FIG. 2, the supporting station includes three supporting members 15, a substantially horizontal central member 15 and two tilted lateral members 15, located on either side of the central member. Typically, it is the layout of the supporting members 15 which gives its shape as a deep trough to the conveyance strand 7. For example, the members 15 are rollers or sliders.

The strand 7′ of the conveyance belt typically is not provided for transporting materials. It is designated by the term of return strand in the description which will follow. Consequently, on the major portion of its length, it has a planar shape, as illustrated in FIG. 2.

Alternatively, the return strand 7′ is provided for the transport of materials. In this case, it is laid out as a trough, like the conveyance strand.

However, it then has planar portions, typically upstream from the station for loading the materials on the return strand, and downstream from the station for unloading the materials from the return strand.

The supporting stations 11 of the return strand themselves include a bearing structure 13 and at least one supporting member 15.

In the planar portions of the return strand, the member 15 is substantially horizontal. It typically extends over the whole width of the conveyance belt. The supporting member 15 again is a roller or a slider.

Typically, certain supporting stations 11 are dedicated to the transport strands and other supporting stations 11 are dedicated to the return strands.

Alternatively, the supporting stations 11 are common to the transport strands and to the return strands and include supporting members 15 for the transport strand and other ones for the return strand.

The conveyance belt 3 includes at least one longitudinal segment 17 tensioned between first and second tension members. In the exemplary embodiment illustrated in FIG. 1, the belt conveyor is substantially rectilinear, each strand 7, 7′ of the conveyance belt thus being a longitudinal segment tensioned between the two return drums 5. The return drums thus are the first and second tension members.

Alternatively, the belt conveyor is not a rectilinear path and includes several rectilinear portions connected through bends. In this case, each strand of the belt is subdivided into several longitudinal segments 17, each tensioned between tension members located at its ends, these members being for example return drums or supporting stations.

The belt conveyor 1 again comprises a device 21 for assessing the tension of one of the longitudinal segments 17, as visible in FIG. 2.

Typically, the tension is substantially constant all along the belt, so that the tension measured at the segment 17 is representative of the tension of the whole belt.

The assessing device 21 is laid out so as to assess, in a determined measurement point, a deviation e of the segment relatively to a reference level Nref. The deviation e typically corresponds to the sag of the segment 17.

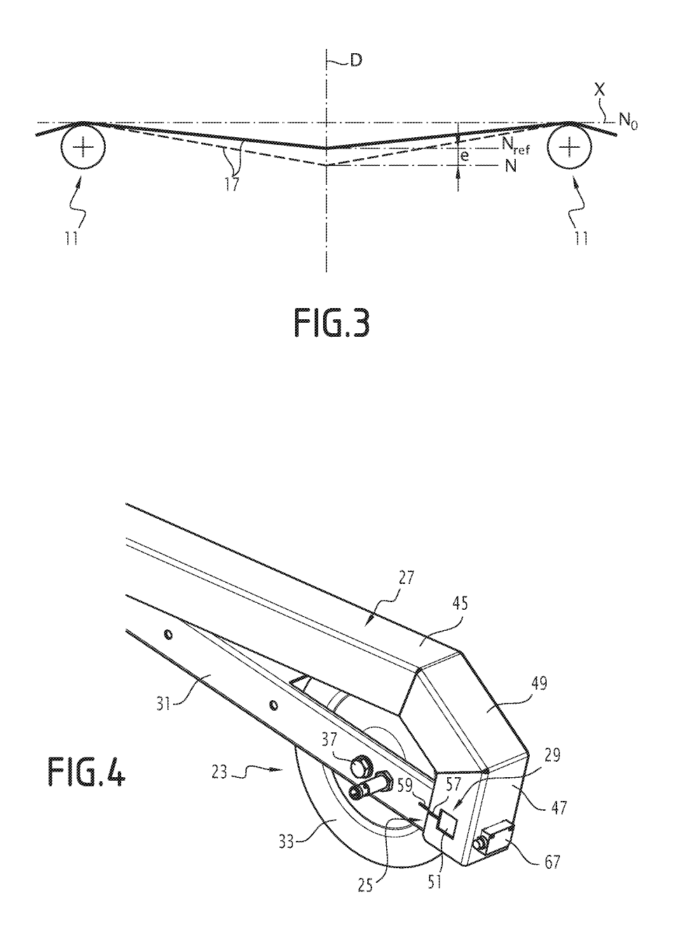

The deviation is taken along a measurement direction D, visible in FIG. 3, which forms a non-zero angle with the longitudinal direction X. The measurement point is located, as shown in FIG. 3, between two consecutive supporting stations 11, in proximity to the central point located longitudinally at an equal distance from both consecutive supporting stations 11.

The measurement point is located for example at a longitudinal distance from the central point of less than 15% of the total length L separating both stations 11, preferably less than 10% of the total length.

Thus, the measurement point is located at the location where the conveyance belt segment 17 has a sag as large as possible. The reference level Nref is typically the level of the belt segment 17 at the measurement point when this segment 17 has a rated tension recommended for the operation of the belt conveyor. This rated tension is specified by the manufacturer of the belt conveyor, according to a certain number of parameters such as the displacement velocity of the conveyance belt, its load per unit length, the path of the belt conveyor, etc.

As visible in FIG. 3, the belt segment 17 is at a level N₀ at the supporting members 15. Because the conveyance belt is in a non-rigid material, the belt segment, at the measurement point is at a level below the level N₀. If the tension of the belt segment 17 is less than the rated tension, the belt segment at the measurement point is at a level N of less than the level Nref, as illustrated in FIG. 3. On the contrary, if the tension of the belt segment is greater than the rated tension, the belt segment at the measurement point is at a level above the level Nref. The deviation of the belt segment relatively to the reference level therefore gives the possibility of assessing the tension of the belt segment.

The measurement direction D is typically formed perpendicular to the longitudinal direction.

Preferably, the measurement direction is vertical. In the illustrated example, the longitudinal direction X is horizontal and the measurement direction D is vertical.

Alternatively, the measurement direction D is not vertical. This may be for example the case when the longitudinal direction is tilted relatively to the horizontal, i.e. when the conveyor is installed on a slope.

Typically, the device 21 for assessing the tension is installed so that the measurement point is on the return strand 7′ of the conveyance belt. Alternatively, the measurement point is located along the transport strand 7.

Preferably, the measurement point is located in an area where the conveyance belt 3 is planar, i.e. is not conformed as a trough. Alternatively, the assessing device 21 is laid out so that the measurement point is located at a location where the conveyance belt is not planar.

According to a first embodiment, the device 21 for assessing the tension comprises:
a follower member 23, laid on the belt segment 17 to said measurement point and bearing at least one movable marking 25;
a fixed member 27, with a position independent of the tension of the belt segment 17 and bearing at least one fixed marking 29.

The deviation of the belt segment 17 relatively to the reference level Nref is assessed by the position of the movable marking 25 relatively to the fixed marking 29.

Indeed, the level of the follower member 23, and therefore of the movable marking 25, follows that of the belt segment 17 at the measurement point, and therefore varies according to the tension of the belt segment 17. On the contrary, the level of the fixed marking 29 is independent of the tension of the belt segment.

In the example illustrated in FIGS. 2, 4 and 5, the follower member 23 comprises an arm 31 bearing a supporting member 33 laid on the belt, and a connection 35 of the arm 31 to the chassis 9 allowing displacement of the arm 31 relatively to the chassis 9 in a plane containing the measurement direction D.

The supporting member 33 is typically a wheel rotatably mounted on the arm 31 around a transverse axis 37. The wheel rolls on a face of the belt segment 17 turned upwards.

The connection 35 is typically a pivot connection around a transverse pivot axis.

For example, the connection 35 includes a transverse tube 39 rigidly attached to the chassis 9. The tube 39 is positioned above the belt segment 17. As visible in FIG. 2, the chassis 9 includes in the illustrated example, two longitudinal beams 41, positioned transversely on either side of the belt segment 17. The bearing structure 13 of the supporting stations 11 is rigidly attached to the beams 41. The beams 41 rest on the ground via legs not shown.

Opposite transverse ends of the tube 39 are rigidly attached to the beams 41 by any suitable means, for example by jumpers 43 in the illustration of FIG. 2.

The supporting member 33 is mounted to a first end portion of the arm 31, the latter being mounted so as to pivot around the tube 39 by a second end portion opposite to the first.

The fixed member 27, in the example illustrated in the figures, is an arm rigidly attached to the tube 39 by any suitable means. This arm includes a longitudinal segment 45, a normal segment 47 oriented substantially parallel to the measurement direction D and an intermediate segment 49 connecting the segments 45 and 47 together.

The segment 45 is rigidly attached by a longitudinal end to the tube 39, and connected by its opposite longitudinal end to the intermediate segment 49.

It extends above the follower member 23, and forms with the latter a variable angle depending on the tension of the belt segment 17.

For example, the segments 45, 47 and 49 of the fixed member are U-profiles, the wheel 33 being engaged onto a portion of its periphery inside the segments 45, 47 and 49.

The fixed marking 29 is made on the normal segment 47.

In the illustrated example, the fixed marking 29 includes a window 51, and the movable marking 25 includes at least one mark 53, for example a spot.

Alternatively, the window 51 is part of the movable marking 25 and the mark 53 is part of the fixed marking 29.

The fixed marking and the movable marking are laid out so that the mark 53 does not appear in the window 51 when the deviation of the belt segment relatively to the reference level Nref is less than a predetermined value, and appears in the window 51 when the deviation of the belt segment relatively to the reference level Nref is greater than a predetermined value (see FIG. 5).

The mark 53 is made on the end portion of the arm 31 bearing the supporting member 33. This mark 53 is located above the window 51 when the deviation of the segment relatively to the reference level Nref is zero. When the tension of the segment is less than the rated tension, the deviation e downwards increases. When the tension of the segment is less than a determined tension, for example 80% of the rated tension, the deviation becomes greater than the predetermined value and the mark 53 appears in the window 51.

The mark 53 has a different color from that of the area of the arm 31 appearing in the window 51 when the belt segment has its rated tension. For example, it is of a red color or of any other easily visible color for an operator.

Advantageously, the movable marking 25 includes another mark 55 which appears in the window 51 when the deviation of the belt segment 17 relatively to the reference level Nref is greater than a predetermined value, but in the opposite direction of the first spot 53. The other mark 55 is otherwise invisible.

More specifically, and as visible in FIG. 5, the mark 55 is located under the window 51 when the belt segment 17 has its rated tension. When the belt segment 17 has a tension greater than its longitudinal tension, the belt segment 17 at the measurement point deviates from the reference level Nref upwards. When this deviation exceeds the predetermined value, the mark 55 appears in the window 51.

The mark 55 is for example a spot.

Advantageously, the fixed marking 29 further includes a fixed mark 57, and the movable marking 25 comprises a movable mark 59, coinciding with the fixed mark 57 when the belt segment 17 has its rated operating tension. This situation is illustrated in FIG. 4. The fixed and movable marks 57, 59 give the possibility of easily verifying that the tension of the belt segment is at its rated tension.

In the example illustrated in FIG. 4, the fixed and movable marks 57, 59 are lines. These lines are aligned when the belt segment 17 has its rated tension.

Alternatively, the fixed and movable marks 57, 59 are not lines, but are points or have any other suitable shape.

The fixed mark is made on the normal segment 47 of the fixed member 27. The movable mark is made on the end portion of the arm 31 bearing the supporting member 33.

Alternatively, the window 51 is replaced by a graduated scale. The mark 55 is replaced by a mark which moves along the graduated scale when the tension of the belt segment varies.

It should be noted that the follower member 23 is advantageously a rotation controller provided for measuring the displacement velocity of the conveyance belt 3 relatively to the chassis 9. It is then equipped with a sensor laid out so as to measure the rotation velocity of the wheel 33. The movement velocity of the belt 3 is calculated from the thereby measured rotational velocity and from the diameter of the wheel 33.

The addition of the fixed member 27, of the movable marking 25 and of the fixed marking 29 gives the possibility of benefiting from the presence of the rotation controller in order to assess in a simple way the tension of the belt segment 17.

According to an alternative embodiment not shown, the fixed member is not an arm fixed to the tube 39. For example it includes in addition to the normal segment 47, a structure allowing direct attachment of this normal segment 47 to the chassis 9, for example to the beams 41.

On the other hand, the embodiment illustrated in FIGS. 2, 4 and 5 is particularly convenient for mounting the device 21 for assessing the tension. Indeed, the tube 39, the follower member 23 and the fixed member 27 are initially assembled to each other but the tube 39 is then attached on the chassis.

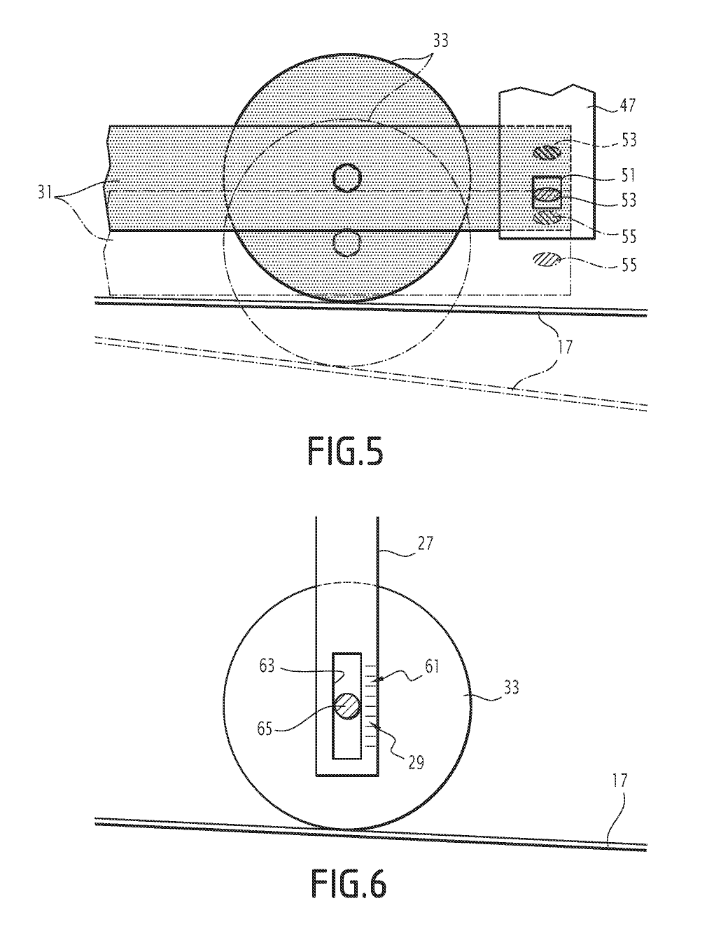

An alternative of the first embodiment of the invention will now be detailed, with reference to FIG. 6. Only the points by which this alternative embodiment differs from that of FIGS. 2, 4 and 5 will be detailed below.

In the alternative embodiment of FIG. 6, the follower member 23 comprises, in addition to the supporting member 33 laid on the belt 3, a sliding connection 61 of the supporting member 33 to the fixed member 27, allowing sliding of the supporting member 33 relatively to the fixed member 27 along the measurement direction D. The supporting member 33, as previously, is a wheel. Alternatively, it is a slider or any other suitable supporting member.

For example, the wheel 33 is mounted in a screed not shown, itself slidably mounted relatively to the fixed member 27 by a sliding connection 61. The sliding connection 61 for example includes a slot 63 in which slides a guiding member 65 attached to the supporting member. The fixed marking 29 is for example a graduation made along the slot 63. The movable marking is borne by the guidance member 65 and therefore moves along the graduation. The position of the movable marking along the graduation gives the possibility of assessing the tension of the belt. The guidance member 65 is for example a rod connected to the screed, or is the axis of rotation of the wheel 33.

According to a second embodiment, illustrated in FIG. 4, the assessment device 21 comprises an ultrasonic distance sensor 67.

This sensor is arranged for measuring the distance between said sensor 67 and the belt segment 17, at the measurement point. The assessment device 21 further comprises a member such as a computer laid out for inferring the deviation of the belt segment 17 relatively to the reference level Nref from the measured distance.

For example, the computer includes a memory in which is stored a reference distance between the sensor 67 and the segment 17 when the belt segment has its rated operating tension. This reference distance is a predetermined distance entered by the operator into the memory of the computer, or further is measured by means of the ultrasonic distance sensor 67 after each phase for adjusting the tension of the belt.

The deviation of the segment relatively to the reference level is determined by subtracting the reference distance from the measured distance.

Typically, the ultrasonic distance sensor 67 is mounted on a fixed structure, and therefore has a position independent of the tension of the belt segment 17. The fixed structure is for example the fixed member 27 described above with reference to FIGS. 2, 4 and 5. Alternatively, the fixed structure is a different structure, directly attached on the beams 41.

The ultrasonic sensor 67 is laid out so as to take the distance between the belt segment and the sensor along the measurement direction D.

Alternatively, the evaluation device includes both the follower member 23 and its movable marking 25, the fixed member 27 and its fixed marking 29, and the ultrasonic distance sensor 67, as illustrated in FIG. 4.

The operation of the belt conveyor will now be described.

The conveyance belt 3 is initially mounted on the supporting chassis 9. During an initial adjustment phase, the tension of the conveyance belt 3 is adjusted to its rated tension. This is achieved with means provided for this purpose, for example by displacing the return drums.

The adjustment of the tension is controlled by using the movable marking 25 and the fixed marking 29, and more specifically the movable mark 59 and the fixed mark 57. The operator visually checks that both marks are well placed, coinciding with each other. In the illustrated example, he/she checks whether both lines are well aligned with each other.

During the operation of the belt conveyor, an operator periodically checks whether the tension of the segment 17 of the belt remains acceptable. For this, he/she checks whether one of the marks 53, 55 appears in the window 51.

When the assessment device includes a distance sensor with ultrasonic waves, it checks whether the measured deviation by means of the ultrasonic distance sensor remains in a predefined interval.

If the operator sees the appearance of a mark 53, 55 in the window 51, he/she stops the conveyance belt and proceeds with a new adjustment of the tension of the belt, so as to bring back the latter to its rated value.

1. A belt conveyor, the conveyor comprising:
a conveyance belt having at least one longitudinal segment tensioned between first and second tension members;
a device for evaluating the tension of said segment, laid out for evaluating, in a determined measurement point located longitudinally between the first and second tension members, a deviation (e) of the segment relatively to a reference level, the deviation being taken along a determined measurement direction forming a non-zero angle with the longitudinal direction.

2. The conveyor according to claim 1, wherein the conveyor comprises a plurality of stations for supporting the conveyance belt, the measurement point being located between two consecutive supporting stations separated longitudinally by a determined total length, a central point being located longitudinally at equal distance from said two consecutive supporting stations, the measurement point being located at a longitudinal distance from the central point of less than 15% of the total length.

3. The conveyor according to claim 1, wherein the measurement direction is substantially perpendicular to the longitudinal direction.

4. The conveyor according to claim 1, wherein the evaluation device comprises an ultrasonic distance sensor.

5. The conveyor according to claim 1, wherein the assessment device comprises:
a follower member, laid on the segment at said measurement point and bearing at least one movable marking;
a fixed member, with a position independent of the tension of the segment and bearing at least one fixed marking, the deviation of the segment relatively to the reference level (Nref) being evaluated by the position of the movable marking relatively to the fixed marking.

6. The conveyor according to claim 5, wherein one of the fixed marking and of the movable marking comprises a window, the other one of the fixed marking and of the movable marking comprising at least one mark, not appearing in the window when the deviation of the segment relatively to the reference level is less than a predetermined value and appearing in the window when the deviation of the segment relatively to the reference level (Nref) is greater than the predetermined value.

7. The conveyor according to claim 5, wherein the fixed mark comprises a fixed mark, the movable marking comprising a movable mark coinciding with the fixed mark when the belt segment has a rated operating tension.

8. The conveyor according to claim 5, wherein the conveyor includes a chassis for guiding and supporting the belt, the follower member including an arm bearing a supporting member laid on the belt and a connection of the arm to the chassis allowing a displacement of the arm relatively to the chassis in a plane containing the measurement direction.

9. The conveyor according to claim 5, wherein the follower member comprises a supporting member laid on the belt and a sliding connection of the supporting member to the fixed member allowing sliding of the supporting member relatively to the fixed member along the measurement direction.

10. The conveyor according to claim 8, wherein the supporting member is a wheel.
